(19) United States
(12) Patent Application Publication
(10) Pub. No.: US 2004/0066762 A1
(43) Pub. Date: Apr. 8, 2004

(54) Data communication system

(76) Inventor: Ari Alastalo, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/467,632

(22) PCT Filed: Feb. 8, 2002
(86) PCT No.: PCT/IB02/01219

(30) Foreign Application Priority Data
Feb. 9, 2001 (GB) 0103274.7

(51) Int. Cl. H04J 3/00; H04L 12/28; H04L 12/56

(52) U.S. Cl. 370/329; 370/341

(57) ABSTRACT

A data communication system and a method for use in a data communication system is disclosed. The system comprises a plurality of nodes (1-7) provided with means for wireless data communication. At least one directed wireless communication link (DCHB) can be formed between a node and another node for data communication. In the method control information is generated, said information associating with at least one node of the plurality of nodes. Said control information includes at least a capacity parameter that associates with the capacity of said at least one node. Data communications between the nodes are scheduled based on said control information and data is communicated between the nodes via said at least one directed link based on said scheduling.

### FIELD OF THE INVENTION

The present invention relates to a data communications system, and in particular, but not exclusively, to a system comprising at least two nodes that are capable of communicating with each other over an air interface. The nodes may be data communication network elements such as routers or access points.

### BACKGROUND OF THE INVENTION

In a data communication system data may be transported between an originating i.e. transmitting node and a destination i.e. receiving node. A data transmission between the transmitting and receiving nodes may need to be transported via one or several intermediate nodes on the route between the transmitting and receiving nodes. In order to enable a transportation of the data to a correct destination address, a functionality referred to as routing is required. A node providing the routing function is referred to as a router. In the routing operation the data is typically routed i.e. directed either directly to the destination node or to another router node on the route towards the destination node.

Data communication systems enabling data transmission over an air i.e. wireless interface are known. An exemplifying wireless system is the so called wireless local area network (WLAN). The user terminals of a WLAN system are connected to access points of the WLAN via air interfaces. By means of this the WLAN provides mobility for the users thereof. However, the price to capacity ratio of the present WLAN applications is not considered to be especially good.

In a wireless data communication system data can be transmitted over a wireless interface between two or more stations. The stations may be fixed or mobile stations. An example of the fixed station is a wireless router radio node. An example of the mobile station is a 3G mobile user equipment such as a third generation (3G) mobile telecommunications system mobile terminal. UMTS (Universal Mobile Telecommunication Service) is an example of the 3G standards.

The fixedly assembled components of a data network may also be in wireless communication with each other. For example, a router node may comprise a wireless IP (internet protocol) router, such as a wireless routing radio (WRR). A wireless router node may be based on use of time-division duplexing (TDD) together with time-division multiple access (TDMA).

In order to avoid a situation in which a wireless transmission causes interference to another transmission in the system and to ensure that the transmission can be received by the receiving station the transmissions need to be scheduled. The scheduling i.e. the order in which the neighbouring nodes may communicate on the radio channels can be based e.g. on the so called Neighbourhood Established Transmission Scheduling (NETS) scheme. The term ‘neighbouring nodes’ typically refers to those nodes in the neighbourhood of a node with which said one node can directly communicate with and with which said node has established neighbour relations. A node may choose that not all nodes that the node, at least in principle, could directly communicate with are its neighbours.

In the NETS scheme the nodes schedule their active radio links in the data channel such that various transmissions do not collide with each other and also such that the receiving station knows that it should receive data at a given moment of time in the future. For example, if a first node has reserved a time to transmit to a second node, the second node should prepare to receive at this time. Furthermore, all nodes that are located in the neighbourhoods of the first and second nodes should remain silent during the transmission in order to avoid interference.

In the conventional wireless data communication arrangements data is transmitted on a data channel by means of omnidirectional antenna arrangements. The omnidirectional transmission may cause substantial interference in all directions around the transmitting station. Thus it is especially important that all neighbouring stations remain silent during the transmission between the two stations.

Antenna arrays enabling directional transmission between two stations has been suggested in order to reduce the interference caused by omnidirectional antennae. Consequently a first node with a directional antenna should be allowed to transmit to a second node as long as the directional beam does not interfere with other active transmission links between other nodes. Directional beams can be used both for the reception and for the transmission.

A directional beam may be provided, for example, by means of so called switched beams or digital beam forming. The term ‘smart antenna’ is commonly use to refer to an antenna arrangement providing digital beam forming. However, the inventor has found that the original NETS scheme does not optimally benefit from the use of directional beams.

The inventor has also found that it might be possible to increase the capacity of the wireless data communication system if the nodes could share at least a portion of the radio resources during the transmission and/or reception of data. That is, it could be advantageous if a node of the data communication system could communicate with at least two other nodes at the same time. it could be even more advantageous if the resources could be shared in both transmission and reception of data between the nodes.

### SUMMARY OF THE INVENTION

Embodiments of the present invention aim to address the problem related to the limited capacity of the prior art wireless data communication systems.

According to one aspect of the present invention, there is provided a method in a data communication system, said system comprising a plurality of nodes provided with means for wireless data communication, the method comprising: generating control information that associates with at least one node of the plurality of nodes, said control information including at least a capacity parameter associated with the capacity of said at least one node; scheduling data communications that associate with said at least one node at a given moment of time, said scheduling being based on said control information; forming a directed wireless data communication link between a node and another node; and communicating data between the nodes based on said scheduling.

According to another aspect of the present invention there is provided a data communication system comprising: a plurality of nodes, each of the nodes being provided with antenna means that are adapted to provide directed wireless data communication links with the others of the nodes; and means for communicating control information between the nodes, the control information including capacity information associated with at least one of the nodes, wherein the arrangement is such that data communications between the nodes over said directed communication links are scheduled based on said control information.

The embodiments may increase the capacity of a wireless data communication system. The capacity may be especially increased in embodiments where space division multiple access (SDMA) is used for the wireless data communication.

### BRIEF DESCRIPTION OF DRAWINGS

For better understanding of the present invention, reference will now be made by way of example to the accompanying drawings in which:

FIG. 1 shows a wireless data router system;

FIG. 2 illustrates data communication between neighbouring nodes of a wireless data communication system;

FIG. 3 shows a smart antenna arrangement;

FIG. 4 is an example of the reservation of time slots for data communication in a frame; and

FIG. 5 is a flowchart illustrating the operation of one embodiment of the present invention.

### DESCRIPTION OF PREFERRED EMBODIMENTS OF THE INVENTION

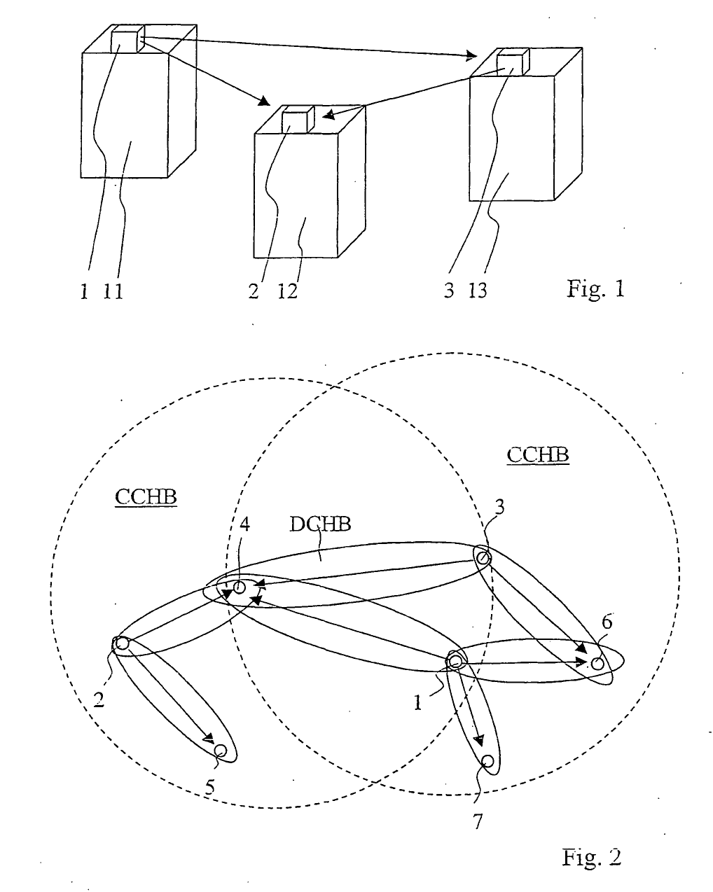

Reference is made to FIG. 1 which shows a wireless data communication system comprising three wireless router nodes 1 to 3. The exemplifying router nodes are positioned on top of tall buildings 11 to 13 respectively. However, it shall be appreciated that manner how the router nodes are installed relative to the buildings is not an essential feature of the invention. A router node may be installed, for example, to the wall of a building, on the ground or on a specific construction designed solely for the purpose of supporting one or several router nodes. Each router node may comprise a wireless IP (internet protocol) router.

Each of the router nodes 1 to 3 is provided with transceiver means to enable wireless transmission and reception therebetween. The data transmissions at a given moment between the nodes 1 to 3 are indicated by the arrows between the nodes.

Although not shown for clarity reasons, a user terminal, such as a PC terminal or a mobile data processing device, may also have a wireless connection with a node providing an access point of the data network. The access point may be provided in one or all of the nodes 1 to 3 of FIG. 1, or may be provided in a separate access node, such as a base transceiver station. A user terminal may also have a fixed connection to the routers. Furthermore, a user terminal may also provide a router.

FIG. 2 is a schematic top view of a system that employs a plurality of wireless router nodes. The schematised wireless router node arrangement is shown to comprise seven nodes 1 to 7. The two circles drawn with dashed lines and designated by reference characters CCHB illustrate the substantially omnidirectional control channel radiation patterns about nodes 3 and 4. It shall be appreciated that although all nodes may have substantially omnidirectional control channel radiation pattern or their own, only two control channel radiation patterns CCHB are shown for clarity reasons.

In accordance with the principles of the invention techniques the nodes are arranged to provide directional data communication between each other by means of directed data channel beams DCHB. The arrows between the nodes indicate the direction of data transmissions between the various neighbouring nodes occurring in a given moment of time.

It shall be appreciated that the FIG. 2 illustration applies only for a given radio propagation environment. The number and shape of the radiation beams DCHB for the data transmissions that are directed towards the indented receiving neighbouring nodes will depend on the application and the environment.

More particularly, in a given moment of time (such as in a given single timeslot of a TDMA system) node 1 is shown to transmit to three different nodes 4, 6 and 7 at a same timeslot. Nodes 2 and 3 each transmit to two different nodes such that node 2 transmits to nodes 4 and 5 and node 3 transmits to nodes 4 and 6. Thus node 4 receives from three nodes, i.e. from nodes 1, 2 and 3. Node 6 receives from two nodes, i.e. from 1 and 3. Nodes 5 and 7 receive from one node only, i.e. from nodes 2 and 1, respectively.

At least some of the wireless router nodes 1 to 7 is provided with antenna means that are adapted to direct the transmission to a desired location. Alternatively, or additionally, at least some of the wireless router nodes 1 to 7 is provided with antenna means that are adapted to direct the reception thereof towards a desired location. The directed transmission and/or reception may be provided by means of the directional transmission and reception beams. In a typical directive reception arrangement power received from a desired location is maximised.

A directional transmission or reception beam may be provided by a so called smart antenna arrangement. A smart antenna arrangement may provide a number of transmission and reception branches. A smart antenna system may be analogue or digital. The term smart antenna arrangement can typically, but not always, be understood to refer to an arrangement comprising the physical antennas, means to weight the transmission and receptions corresponding to the different antennas and an algorithm or method to obtain proper antenna weights.

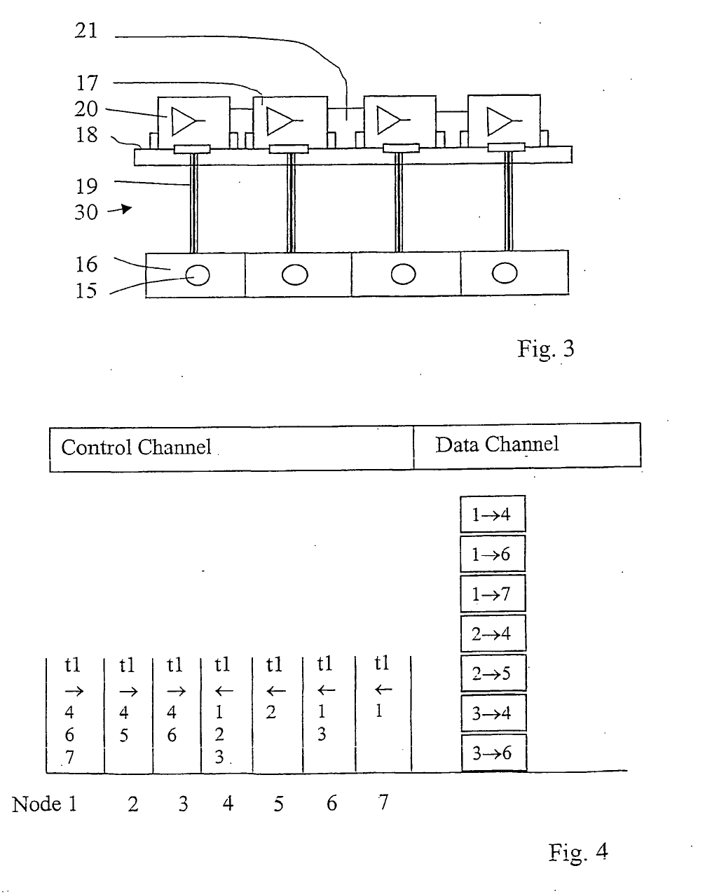

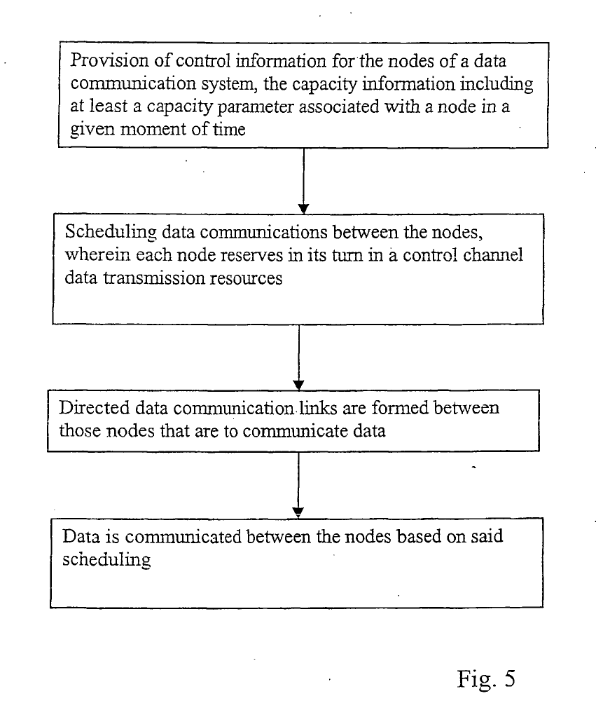

FIG. 3 is a schematic illustration of a smart antenna arrangement 30 comprising four transmission branches. Each of the branches is preferably capable of serving the entire coverage area of the transceiver. A transmission branch may comprise an antenna element 15, a power amplifier 20 and digital or analogue circuitry 21 required to generate the signal to be transmitted by the antenna element 15. The antenna element 15 may be mounted on a mounting rack or similar mounting means 16.

An appropriate control equipment housing may also be provided. The housing may comprise a rack 18 for receiving the amplifier 20 and other circuitry 21 that may be required for the generation of the directed beam. The control instrument housing is preferably located such that it is readily accessible for maintenance and upgrade operations. In a preferred embodiment the antenna elements 15 are located as high as possible while the housing is located on the ground or the roof or elsewhere such that an easy access for maintenance and/or upgrade purposes is enabled. The element 15 and the equipment in the housing are connected by means of appropriate cabling 19.

The beams i.e. radiation patterns produced by the array arrangement 30 can be shaped to have a narrower or broader radio coverage. Digital beamforming (DBF) can be advantageously employed in the provision of the directional beams. Advantages may be obtained since the digital beamforming enables tuning of the radiation pattern of an antenna array to have a desired shape. By mean of the desired shape the radiation pattern can be directed to point to a selected direction. In a typical digital beamforming implementation each branch is connected to an antenna element or antenna element polarisation port.

In the digital beamforming the transmission radiation pattern (beam) may be formed at the baseband by means of appropriate phasing and amplitude of the signal in each transmission branch. This may be accomplished by multiplying the complex digital samples in each transmission branch with a complex weight factor. The set of weight factors (one factor for each branch) is called the weight vector. A different weight vector may be used for transmission and reception. The digital beam forming enables provision of different number of transmission and reception beams.

In an analogue fixed beam implementation the beam may be formed e.g. by an analogue Butler matrix permanently connected to an antenna array. Thus when the same array is used for the transmission and reception, the number of transmission and reception beams will be the same. For example, antenna means may provide eight directional reception and transmissions beams. In other words, in an analogue implementation a transmission branch produces a fixed transmission beam covering a geographical coverage area on which the transmitter may transmit to another station within the beam coverage area.

In both the analogue and digital implementations a greater number of branches typically provides a better capacity. The beams can be made narrower and thus the area served by a beam can be made smaller and pointed more precisely towards the counterpart in the communication.

The data transmissions between the nodes are preferably based on time-division multiple access (TDMA) together with space division multiple access (SDMA) technique and on time division duplexing (TDD). The relation between the TDMA and SDMA schemes is such that the TDMA defines the allocation of time slots for transmissions whereas the SDMA defines allocation of transmission resources within a time slot allocated based on the TDMA. In other words, SDMA enables division of a TDMA time slot so that data associated with more than one data transmission may be carried by means of said single time slot.

Both the transmitting and receiving stations are capable of operating in accordance with the SDMA scheme. The use of space division multiple access is advantageous since it can be used to increase the capacity of the data network. In the embodiments based on use of the SDMA advantages are especially obtained if control Information that associates with smart-antennas of the nodes is shared between the router nodes of the system.

The control information may comprise several different parameters that may be used in the scheduling. The control information includes at least capacity parameter of a receiving node. If transmissions to more than one node are scheduled at the same time, the control information may include appropriate information by means of which it is possible to separate the nodes from each other.

The scheduling is distributed in the nodes. Each of the nodes may determine, e.g. based on a medium access control (MAC) address, when it is time to transmit on the control channel. That is, each node is allocated with a slot on the control channel.

In systems such as the space division multiple access (SDMA) the separation can be based on so called spatial signatures of the nodes, the spatial signatures describing the spatial characteristics of the respective radio channels between the neighbouring nodes. That is, nodes that are served in the same timeslot can be separated from each other based on their individual spatial signatures.

The spatial signatures of the neighbouring nodes are usually estimated based on training signals that have been sent by the nodes. Each node estimates the spatial signatures (with respect to itself) of all those other nodes that are located in its neighbourhood. The estimation may be based on continuous monitoring of the transmissions by the neighbouring nodes. Methods to obtain the SDMA weights for smart-antenna combining in transmission and reception are known and will thus not be explained in full detail. However, an example of a possible method for the spatial signature determination will be given later.

In the embodiments of the present invention the maximum number of simultaneous communications (transmissions and receptions) a router node can handle is defined by a specific parameter. This parameter will be referred to in the following as capacity parameter and occasionally, where more appropriate, also as

$${C}_{SDMA}^{N}$$

value. In

$${C}_{SDMA}^{N}$$

the character ‘N’ labels the particular node.

The capacity parameter typically depends on the number of antenna elements that are used for forming the beams. In theory, N antenna elements can handle N-1 independent beams. In practice the capacity parameter may be smaller than N-1 depending e.g. on the radio propagation environment, interference and so on.

In the embodiments the capacity parameter is communicated to the neighbouring nodes. The communication occurs, for example, over a control channel between the nodes. However, it is not necessary to communicate the capacity parameter in each control-channel message since in a typical application the value of the capacity parameter is not likely to change very often.

The control channel transmissions are preferably arranged to be based on non-directional transmission and reception patterns. For example, as shown by FIG. 2, the control channel radiation patterns CCHB may have substantially omnidirectional shape about the nodes. That is, all the nodes in the neighbourhood of a node should receive the control-channel information regardless the directional location of the nodes. The data channel is made feasible for the operation of the smart-antenna arrangement providing directional beams, as described above.

The following describes how the control channel information may he employed in the SDMA data transmission scheduling. It is assumed in the following that each node is provided with information regarding the values of the capacity parameters of its neighbours. The following description assumes also that node 1 is provided with a timeslot on the control channel of the current frame. In this timeslot the node 1 specifies those nodes to which it will transmit data on the current frame and/or from which it will receive data on the current frame. The node 1 may also specify this for at least some of the future frames. These reservations will be referred to in this specification as active links.

The following will describe also several other parameters that can be included in the control information, such as parameters associated with transmit and receive directivities. However, information that is not likely to change, such as the. transmit and receive directivities, or changes only rarely, is preferably not included in every control channel transmission.

The start times and duration of the active links may also be specified in the reservations. Node 1 may base the decisions regarding the timeslots for its active links on information it has received from the other nodes about their forthcoming transmissions during the earlier control channel timeslots to avoid collisions. In order to enable the scheduling operations the nodes are adapted to interpret the received control channel information to decide in which time slots they can perform their transmissions and in which time slots they should be prepared to receive.

As explained above, e.g. in the conventional Neighbourhood Established Transmission Scheduling (NETS) scheme the nodes try to schedule their active links such that none of the transmissions collides with another transmission. For example, if the node 1 has reserved a time to transmit to node 2 in accordance with the NETS, all the nodes in the neighbourhoods of nodes 1 and 2 shall remain silent during this transmission in order not to cause interference.

The embodiments enable use of a scheduling scheme that is not as rigid as e.g. the conventional NETS. In this context the SDMA is advantageous since it enables simultaneous transmission and/or reception to and/or from several different nodes. The transmission and/or reception may occur simultaneously in common timeslots.

A simultaneous communication with several nodes may be accomplished if a node is capable of handling more than one reception simultaneously, that is if

$${C}_{SDMA}^{N} > 1$$

and if the node can separate the data in the incoming signals. Generally, a node is allowed to schedule a transmission to another node at time T if the number of already scheduled simultaneous transmission to said other node during that time is less than the

$${C}_{SDMA}^{N}$$

value of said other node.

The use of the directional beams and the SDMA based allocation of the transmission resources enables the scheduling rule for the neighbouring nodes to be such that it is not necessary for the neighbouring nodes to be silent. The directional beams may be implemented, or example, by the above discussed switched beams or digital beam forming. In addition, this also makes it possible to transmit to such nodes that are also in communication with other nodes.

FIG. 2 exemplifies a situation in which a number of transmissions and receptions occur simultaneously in, a wireless IP network that utilises an access technique such as the SDMA. As mentioned above, the SDMA enables the neighbours to transmit also to nodes that are in the process of transmitting to and/or receiving from other nodes.

The principle of the scheduling within a time slot is illustrated by FIG. 4. Nodes 1, 2 and 3 are shown to transmit to a plurality of nodes during slot t1. Nodes 5, 6 and 7 are shown to receive from nodes 1 to 3. For example, node 3 is enabled to transmit to nodes 4 and 6 at the same time as node 1 transmits to nodes 4, 6 and 7. Correspondingly, nodes 4 and 6 should receive data from more than one node during this slot t1. For example, node 6 may receive from nodes 1 and 3 at the same time.

The simultaneous active links for communication can be specified by appropriate messages transported on the control channel of the frame, as shown by FIG. 4. The indication mechanism may be similar to the indication of the conventional active links that are intended for different timeslots.

A node that is about to receive from several other nodes simultaneously can separate he received data e.g. based on the above discussed smart antenna weights. Thus e.g. node 6 determines proper smart antenna weights for all transmitting nodes to be able to digitally separate the different incoming signals. These weights can be based on the spatial-signature estimates. It is possible to set also other relevant parameters for this purpose, such as expected values for timing and frequency errors.

Nodes that have a high

$${C}_{SDMA}^{N}$$

value generally use antenna arrays provided with a substantially high number of antenna elements. Transmissions by such nodes can be made highly directional. The substantially narrow beams are not likely to cause significant interference to other simultaneous active links.

On the other hand, nodes with substantially small

$${C}_{SDMA}^{N}$$

value transmit with a low directivity. In particular, nodes with

$${C}_{SDMA}^{N} = 1$$

transmit and receive omnidirectionally unless they use a switched-beams approach or digital beam forming without SDMA. This may be referred to as a single-user smart-antenna operation. Such nodes may cause a substantially strong interference to other simultaneous active links. In order to optimise the operation of the system it may thus be advantageous to reserve simultaneous active links in a common neighbourhood in the same timeslot with those active links that have a substantially high

$${C}_{SDMA}^{N}$$

in the transmitting side.

It is also possible that the system includes nodes for which the

$${C}_{SDMA}^{N} = 1.$$

Of these nodes the ones with omnidirectional antennas are substantially different from the interference point of view from those nodes that use directional transmissions but do not support SDMA.

Thus it may be advantageous in certain situations to include a measure indicative of the transmission directivity of a node to the list of parameters to be communicated to the neighbours in order to optimise further the scheduling or simultaneous communications. Even if the SDMA is not employed, and when the

$${C}_{SDMA}^{N} = 1$$

for all the nodes, capacity can be enhanced through information regarding the transmit and receive directivity since this enables simultaneous active links for neighbouring nodes and enables relaxing the requirements of the basic NETS scheme.

Furthermore, for a single-user smart-antenna operation as well as for the SDMA the nodes can use zeroing (nulling) to further reduce unwanted interference (see the mathematical discussion regarding the interference below). Moreover, to optimise the zeroing performance, the lengths of the simultaneous transmissions in different active links in a common neighbourhood should preferably be as close to each other as possible. Otherwise a varying interference situation may occur during a single data packet—a situation which might not be as easily zeroed as the case with equal transmission lengths.

A measure that is indicative of the reception directivity of the receiving nodes can be of importance to the transmitting node also since the transmitting node may use this information in the scheduling operations to ensure that the transmissions thereof do not cause interference to reception of another active link.

The value of the capacity parameter may change e.g. based on changes in the capacity or in the quality of the radio connection. That is, a node may be upgraded or downgraded to handle more or less simultaneous communications. Furthermore, in situations where the load of the network is substantially high such that it is very unlikely that the node receives from only one other node at a time and if there is only one choice for the training sequence, it may be advantageous if a node is able to temporarily set its capacity parameter value to unity in order to update the spatial-signature estimates for its neighbours. The current value of the capacity parameter may, for example, be included in the control-channel transmissions of each node or in some other control messages that are sent more seldomly.

According to a possibility a set of mutually orthogonal training signals is specified in the system. The transmissions to a node may then be scheduled such that transmissions from different nodes use different training signals. To achieve this information about the training signal that are used can be included in the control channel scheduling messages. Thus, after node 1, for example, has reserved timing for a node 1 to node 6 transmission, any node also wishing to transmit to node 6 at the same time may select a different training signal.

Based on different mutually orthogonal training signals for the different incoming transmissions the receiving node may estimate the spatial signatures during the SDMA operation. Thus it is possible to relax the requirement regarding the speed on which the radio channel may vary in the SDMA reception. Furthermore, to update channel estimates a node may not need to be set the value of the capacity parameter to unity.

The following will describe an exemplifying spatial signature determination procedure that relates to a wireless data communication system employing orthogonal frequency division multiplexing (OFDM) scheme. It shall be understood that the following is only an example, and other methods for the estimation may also be used. In the OFDM the training sequence may consist of two identical consecutive OFDM symbols (training symbols) in which each of the subcarriers contain data that is known to the receiver.

The number of subcarriers depends on the particular communication standard. The following assumes that 52 subcarriers are employed. The system may apply e.g. 64 subcarrier frequencies, but of these only 52 subcarriers are used for data transmission. Of these 52 subcarriers, in turn, four are used as pilot carriers in all OFDM symbols. All the subcarriers used in the training symbols represent predefined data. Thus, the radio frequency radio channel (H) between the terminal and an element n of the array of antennas for a subcarrier k can be estimated by equation:

$${H}_{n} [ k ] = ( \frac{1}{2} {\sum }_{p = 1}^{2} {x}_{n} [ k , p ] ) \times {d [ k ]}^{*} , \qquad ( 1 )$$

in which xₙ[k,p] is a signal received from the antenna element n in the frequency domain at a subcarrier frequency k=0,1, . . . ,51 representing the p^{th} training symbol in a training sequence transmitted by the terminal, d[k] is the training symbol for the subcarrier k, and the character * as superscript indicates complex conjugation.

Because the effect of the radio channel is generally shown in time domain as a convolution with the transmitted signal, this corresponds, at each subcarrier frequency in the frequency domain, to complex multiplication of the transmitted symbol and the radio channel. It is now possible to determine a weight vector, whose complex conjugate is used in the receiving station to weight signals received from the transmitting station by different antenna elements or signals to be transmitted from different antenna elements, for example depending on the frequency in the following way:

\overline{w}[k]=(H₀[k],H₁[k],H₂[k], . . . ,H_{N-1}[k])^{T} (2) [AA1]

In (2) superscript T indicates transposition and N is the number of the antenna elements.

The weighting coefficient vector (2) can be referred to as a spatial signature. The weighting coefficient vector (2) can be used both for reception (uplink) and transmission (downlink).

The access point i.e. router node may apply the space division multiple access (SDMA) for simultaneous transmission to e.g. M different router nodes. In order to enable this the spatial signatures of the different nodes may be generally modified, that is, the weighting coefficients \overline{w}ₘ[k] of the weighting coefficient vector may be modified to the form \overline{w}′ₘ[k] so that when a signal intended for a node m=1, 2, . . . , M is weighted by the weighting coefficients \overline{w}′ₘ[k], the power received by the node m is as high as possible and at the same time the power received by other nodes to be simultaneously served from the transmission in question is as low as possible. Thus, for example, it can be required that:

\overline{w}′ₐ^{H}[k]·\overline{w}_{b}[k]=δ_{a,b}∀k (3)

in which δ_{a,b} is a Kronecker delta (1 if a=b and zero otherwise) and ∀k indicates that the condition is valid for each subcarrier frequency separately. This condition can be fulfilled for example by using the pseudo inverse:

A_{sdma}[k]=(A[k]⁺)^{H}, (4)

in which the superscript + indicates pseudo inverse and N×M matrices A[k] and A_{sdma}[k] are defined:

A[k]=(\overline{w}₁[k],\overline{w}₂[k], . . . \overline{w}_{M}[k]) (5)

and

A_{sdma}[k]=(\overline{w}′₁[k],\overline{w}′₂[k], . . . \overline{w}′_{M} [k]) (6)

A corresponding modification can be accomplished in the receiving node. When a received signal is combined with the weighting coefficients \overline{w}′ₐ[k], the signal transmitted by the transmitting node ‘a’ is amplified as much as possible, whereas the signals transmitted simultaneously by other nodes are attenuated as much as possible. In other words, the signal transmitted by the transmitting node is summed from the different antenna elements as coherently as possible when weighted with the weighting coefficients a \overline{w}′ₐ[k], whereas the signals of other nodes transmitting simultaneously are summed as incoherently as possible.

In most occasions it can be assumed that the weight vector and spatial signature mean essentially the same factor. For example, in FIG. 1 node 1 is provided with an estimate of the direction in which node 2 is located. The weight vector that shall be used to form a transmission beam towards this direction corresponds to the spatial signature of node 2 as seen by node 1. That is, the spatial signature of node 2 depends on the position of node 2 relative to node 1. The weight vector for the forming of the beam from node 1 towards node 2 depends of the spatial signature of node 2 as seen by node 1.

The spatial signature is defined for a link between two nodes. If node 1 transmits to two nodes 2 and 3 at the same time it is possible for node 1 not to use the original weigh factors of nodes 2 and 3. Instead, node 1 may modify the weight factor vectors so that the other one of the two nodes is always zeroed. That is accomplished in order to prevent the transmission that was intended to node 2 to enter node 3 and vice versa (see the discussion above).

If the two nodes have a line of sight (LoS) between them, the direction and location of the receiving station can be considered to be the same. LoS is a typical condition when the router nodes are installed outdoors, such as in FIG. 1. However, if the nodes do not have a visible contact with each other a substantial portion of the radio propagation may be subject to reflections. The reflected signals may arrive from various directions. Thus in certain circumstances it is more correct to understand the operation of a smart antenna system such that it directs the transmission and/or reception to a desired location, not just to a desired direction.

The TDD based systems are advantageous in this sense since the uplink and the downlink use the same frequency. In the TDD based systems it is not necessary to consider the directed transmissions in the terms of directions of the beams but, instead the operation can be seen as a formation of a region of constructive interference around a node. For example, an interference maximum can be located to be present around the location of a receiving node.

The spatial-signature estimates may need an update from time to time, depending on the application. The more slowly varying the radio environment is, the more seldom an update of the spatial-signature estimates is needed and vice versa.

Despite the possibility to update the value of the capacity parameter it may, however, be advantageous in some applications if the radio environment of a node does not vary too rapidly. Too rapid variations in the radio channel conditions may prevent use a spatial-signature estimate for a substantially long enough period of time, e.g. the use of a single spatial-signature measurement for several frames. This may be of especial importance if the system uses only one type of training sequence. This may be the case, for example, for HIPERLAN/2 WLAN as well as for the WRR.

On the other hand, the requirement for slowly-varying radio environment can be relaxed for SDMA reception if a set of mutually orthogonal training signals is specified in the system. More particularly, even if the radio environment varies substantially rapidly the SDMA may still be made feasible in the reception if the system defines a set of mutually orthogonal training signals.

In extreme conditions (e.g. a fast moving node) an estimate of the channel may be needed for every packet in systems that require use of antenna weights for the communication by means or directional radiation patterns. Consequently, the total number of possible simultaneous active links in the neighbourhood of an active link between a first and a second node would be limited by the number of different training signals (C_{TR}) that may be used. Thus in such circumstances the number of simultaneous active links to the second node may become limited by the C_{TR} value in addition to the limitation set by the capacity parameter. However, it shall be appreciated that this is not the case in all applications. For example, if fixedly mounted routers (see FIG. 1) are used the radio channel is expected to remain the same over long enough periods of time.

It is also possible to estimate the interference content of the received signal. This may be done for example by forming a so called remainder signal

rₙ[k,p]=xₙ[k,p]−Hₙ[k]×d[k] (7)

for the training symbols (p=1, 2) that have been transmitted in an orthogonal system. To eliminate interference in the reception, the weighting coefficient vector can now be modified for example by multiplying it with the inverse matrix of the position correlation matrix of the remainder signal:

\overline{w}ₒₚₜ[k]=(Q[k,p]+γ×I)⁻¹×\overline{w}[k], (8)

in which Q[k,p] is the position correlation matrix of the remainder signal:

Q[k,p]=\overline{r}[k,p]×\overline{r}[k,p]^{H}, (9)

\overline{r}[k,p]=(r₀[k,p],r₁[k,p],r₂[k,p], . . . r_{N-1} [k,p])^{T}, (10)

the superscript H indicates complex conjugate transposition, I is N×N unit matrix and γ is a small constant (for example, γ=0.01) which makes the inverse matrix operation well-behaved in the equation (8). In equations (7)-(10) it is possible, for example, to restrict to use only one of the received training symbols, that is, for example to set p=1 in equations (7) and (8). Alternatively, the inverse matrix for the equation (8) can be calculated for each training symbol separately (p=1 and p=2) and to take the average of these inverse matrices. Good simulation results have also been obtained by averaging the position correlation matrix over the frequency, by calculating the inverse matrix as in equation (7), and finally by taking the average over the training symbols:

$${\overline{w}}_{opt} [ k ] = \{ \frac{1}{p} {\sum }_{p = 1}^{P} {[ ( \frac{1}{K} {\sum }_{k = 0}^{K - 1} Q [ k , p ] ) + γ \times I ]}^{- 1} \} \times \overline{w} [ k ] , \qquad ( 11 )$$

in which thus P=2 and K=52 for the HIPERLAN/2 system.

It is also possible that at least one of the transmitting or receiving stations comprises a mobile user terminal. The mobile terminal comprises a mobile station enabled to communicate with another station. At least a part of the nodes of the data communication system may be arranged to provide an access point (AP) for the mobile terminal (MT). The access point may comprise appropriate transceiver and controller means such as those known from the base stations for the cellular telecommunication systems.

The mobile terminals and access points may be arranged such that the mobile terminals have omnidirectional antennae (one for each MT) while the access points may use array antennas as discussed above, measure the spatial signatures of different mobile terminals and utilise the SDMA. Those nodes of the system which do not provide the access point feature may be similar to the router nodes described above. The router nodes may be provided with antenna arrays and utilise spatial signatures of the other nodes. The router nodes may be capable of communication with the other router nodes and also with those nodes that provide the access points. Each of the routers may also transmit to and/or receive from the mobile terminal in the manner similar to reception and/or transmission between the router nodes of the system.

It shall be appreciated that although the above example mainly considers use of a TDD/SDMA system, other duplexing and access techniques may also be used where appropriate. Thus this invention is also applicable to any other access techniques including code division multiple access (CDMA), frequency division multiple access (FDMA) as well as any hybrids thereof. Any multiplexing scheme where time or frequency slots or similar are allocated for the data to be transmitted may also be used.

It shall also be appreciated that whilst embodiments of the present invention have been described in relation to wireless routers, embodiments of the present invention are applicable to any other suitable type of nodes. Consequently the embodiments can be applied to other network elements where applicable.

The data is described as being in packet form. In alternative embodiments of the invention the data may be sent in any suitable format.

Advantage may also be obtained in gateway nodes that connect the wireless network to other networks. This is so because the gateway nodes typically form bottlenecks through which the traffic between a wireless mesh network (typically more local) and a wired network (typically more global) is directed. The gateway nodes are sometimes referred to as sinks.

It is also noted herein that while the above describes exemplifying embodiments of the invention, there are several variations and modifications which may be made to the disclosed solution without departing from the scope of the present invention as defined in the appended claims.

1. A method in a data communication system, said system comprising a plurality of nodes provided with means for wireless data communication, the method comprising:
generating control information that associates with at least one node of the plurality of nodes, said control information including at least a capacity parameter associated with the capacity of said at least one node;
scheduling data communications that associate with said at least one node at a given moment of time, said scheduling being based on said control information;
forming a directed wireless data communication link between a node and another node; and
communicating data between the nodes based on said scheduling.

2. A method as claimed in claim 1, wherein the directed wireless data communication link is formed by means of at least one directional radiation pattern.

3. A method as claimed in claim 2, wherein said at least one directional radiation pattern is formed by a smart antenna arrangement.

4. A method as claimed in any preceding claim, wherein the directed wireless data communication link is formed by means of digital beamforming.

5. A method as claimed in any preceding claim, comprising a step of estimating information associated with the location of said at least one node.

6. A method as claimed in any preceding claim, wherein each of the nodes of the system is allocated with a time slot on a control channel for the provision of control information to the others of the nodes.

7. A method as claimed in any preceding claim, wherein those nodes of the system that are served in a time slot are separated from each other based on information that associates with the spatial characteristics of neighbouring nodes.

8. A method as claimed in claim 7, wherein the information regarding the spatial characteristics of the neighbouring nodes is determined based on training signals.

9. A method as claimed in any preceding claim, wherein data transmissions between the nodes of the system are based on space division multiple access (SDMA) technique.

10. A method as claimed in claim 9, wherein the space division multiple access (SDMA) technique is used in combination with time division multiple access (TDMA) technique.

11. A method as claimed in any of claims 7 to 10, wherein information associated with the spatial characteristics is provided by means of spatial signatures.

12. A method as claimed in any preceding claim, wherein the nodes of the system reserve data communication resources by generating control information and transmitting said control information to other nodes.

13. A method as claimed in any preceding claim, wherein the control information includes information that identifies those nodes to which a node intends to transmit data.

14. A method as claimed in any preceding claim, wherein the control information includes information that identifies those nodes from which a node expects to receive data.

15. A method as claimed in claim 13 or 14, wherein only those nodes are identified with which a node is going to communicate during a data transmission entity.

16. A method as claimed in claim 15, wherein the data transmission entity comprises a time slot, and a node reserves communication resources by providing an indication of those nodes the said reserving node is going to be in communication with during said time slot.

17. A method as claimed in any preceding claim, wherein the control information includes start times and duration of communication links a node is indenting to have with at least one of the nodes.

18. A method as claimed in any preceding claim, wherein the control information includes an indication of transmission and/or reception directivity of a node.

19. A method as claimed in any preceding claim, wherein the control information includes information that is associated with training signals to be used for the data communication between the nodes.

20. A method as claimed in any preceding claim, wherein the capacity parameter for a node defines the number of simultaneous active data communication links the node may have with other nodes.

21. A method as claimed in any preceding claim, comprising a step of updating the capacity parameter.

22. A method as claimed in any preceding claim, wherein the wireless data communication link is formed by means of a transmission beam that is directed to a certain direction.

23. A method as claimed in any of claims 1 to 21, wherein the wireless data communication link is formed by means of a transmission beam that is directed to a certain location.

24. A method as claimed in any preceding claim, wherein time division duplexing (TDD) is used for the communication between the nodes.

25. A method as claimed in any preceding claim, wherein the directed data communication link is formed by arranging multiple transmitted or received signals to constructively interfere at a desired location.

26. A method as claimed in any preceding claim, wherein non-directional communication links are used for communication of said control information between the nodes.

27. A method as claimed in any preceding claim, wherein the nodes transmit said control information on a control channel.

28. A method as claimed in any preceding claim, wherein a node is in simultaneous communication with a plurality of nodes during a common timeslot.

29. A method as claimed in any preceding claim, wherein a node is allowed to schedule a transmission to another node at time T if the number of already scheduled simultaneous transmission to said other node during that time is less than the value of the capacity parameter of said other node.

30. A method as claimed in any preceding claim, wherein at least one of nodes comprises a fixedly mounted router node for a data communication network.

31. A method as claimed in any preceding claim, wherein the data communication systems employs internet protocol for data communication.

32. A data communication system comprising:
a plurality of nodes, each of the nodes being provided with antenna means that are adapted to provide directed wireless data communication links with the others of the nodes; and
means for communicating control information between the nodes, the control information including capacity information associated with at least one of the nodes, wherein the arrangement is such that data communications between the nodes over said directed communication links are scheduled based on said control information.

33. A data communication system as claimed in claim 32, wherein the directed wireless data communication link is formed by means of at least one directional radio beam.

34. A data communication system as claimed in claim 33, wherein the antenna means comprise a smart antenna arrangement.

35. A data communication system as claimed in any of claims 32 to 34, wherein the antenna means comprise means for digital beamforming.

36. A data communication system as claimed in any of claims 32 to 35, wherein the control information includes also information associated with at least one of the following features or characteristics of the communication system: spatial characteristics of neighbouring nodes; indication of those nodes with which a node intends to communicate data; start times and duration of communication links a node is indenting to have with at least one other node; transmission and/or reception directivity of a node; training signals to be used for the data communication between at least two nodes.

37. A data communication system as claimed in any of claims 32 to 36, wherein data transmissions between the nodes of the system are based on space division multiple access (SDMA) technique.

38. A data communication system as claimed in any of claims 32 to 37, wherein the capacity parameter for a node defines the number of active data communication links the node may have at a time.

39. A data communication system as claimed in any of claims 32 to 38, wherein the means for communicating control information comprise non-directional antenna means.

40. A data communication system as claimed in any of claims 32 to 39, wherein a node is enabled to be in simultaneous communication with a plurality of nodes during a common timeslot.

41. A data communication system as claimed in any of claims 32 to 40, wherein at least one of nodes comprises a fixedly mounted router node for a data communication network.
